(19) United States
(12) Patent Application Publication
(10) Pub. No.: US 2009/0160092 A1
(43) Pub. Date: Jun. 25, 2009

(54) Precision casting process

(76) Inventor: David Brian Jahnz, San Diego, CA (US)

Correspondence Address: CATERPILLAR/FINNEGAN, HENDERSON, L.L.P., 901 New York Avenue, NW, WASHINGTON, DC, 20001-4413, US

(21) Appl. No.: 12/003,103

(22) Filed: Dec. 20, 2007

(51) Int. Cl. B29C 39/00; B22C 9/08; B29C 39/26; B29C 39/36; B22C 9/02; B29C 33/38; B22D 23/00; B22D 29/00

(52) U.S. Cl. 264/299; 164/335; 425/447; 164/137; 164/131; 164/132; 264/334; 264/219; 164/37

(57) ABSTRACT

A mold assembly for sand casting is disclosed. The mold assembly includes a drag having a first vertical axis and a first surface. The first surface extends generally perpendicular to the first vertical axis. The mold assembly also includes a cope having a second vertical axis positioned on the first surface such that the first vertical axis and the second vertical axis coincide to form a central vertical axis. The cope includes a second surface and a third surface both extending generally perpendicular to the second vertical axis. The mold assembly also includes a casting cavity disposed about the central vertical axis and located between the first surface and the second surface, and a core disposed about the central vertical axis and positioned in the casting cavity. The mold cavity further includes a pouring cup disposed about the second vertical axis and extending downward from the third surface to the casting cavity. The pouring cup is configured to deliver a substantial portion of liquid material at a time directly into the casting cavity without directing the liquid material through a choke point.

### TECHNICAL FIELD

The present disclosure relates to a precision casting process, and more particularly, to a sand casting process for making precision parts.

### BACKGROUND

Casting is a manufacturing process by which a liquid or a slurry material (such as a metal, a ceramic slurry, or a plastic) is introduced into a mold, allowed to solidify within the mold, and then separated from the mold to make a part. Casting may be used for making parts of complex shape that would be difficult or uneconomical to make by other methods, such as machining, stamping, forging, extrusion, etc. Sand casting is a common casting process. In typical sand casting, molten metal is poured into a mold cavity formed out of sand (natural or synthetic) housed in a box called a flask. The mold cavity is formed in the sand by using a pattern which is an approximate duplicate of the part to be cast. One or more sand shapes, called “cores,” may be used in the mold cavity to produce internal features (such as holes or internal passages) of the part.

In a two-part mold, which is often used in a sand casting, the upper half, including the top half of the flask, is called a “cope” and the lower half is called a “drag.” A parting surface may separate the cope and drag. The drag is first filled partially with sand, and the pattern is placed near the parting surface. The cope is then assembled to the drag. A gating system, for introducing liquid molten metal into the mold cavity, is placed on the cope, and sand is poured on the cope half covering the pattern and the gating system. The sand is then compacted by vibration or other mechanical means, after which the pattern is extracted from the drag by opening the cope. The impression of the pattern on the sand forms the mold cavity. One or more cores may then be placed in the mold cavity to define features, such as internal passages, in a cast part.

The gating system extends from the mold cavity to an outer surface of the cope and allows molten metal to be poured into the mold cavity. At the outer surface of the cope, the gating system may include a pouring cup into which the molten metal is poured. The pouring cup may be fluidly connected to the mold cavity by one or more vertical sections called sprues, and one or more horizontal sections called runners. The molten metal flows from the pouring cup into different sections of the mold cavity through the sprues and the runners. As the molten metal in the mold cavity solidifies, it shrinks, thereby creating voids in the mold cavity that require more molten metal to fill. These voids are often referred to as “shrink defects.” A concept called “directional solidification” may be used in attempt to minimize shrink defects during solidification of the part. Implementing directional solidification concepts may include using one or more “risers” coupled to the gating system. These risers act as reservoirs of molten metal that provide additional material to fill shrink voids. As the molten metal in the mold cavity solidifies, the interface between the molten and the solid metal moves from the region where solidification began toward the risers. After all of the molten metal in the mold cavity solidifies, thereby forming the desired part, the cope is separated from the drag, and the part is extracted by breaking the sand surrounding the part. Any sand cores in the part may then be removed to open internal cavities of the part.

Although sand casting has many advantages, it is desirable to increase the yield of sand casting processes and improve surface finish and microstructure of parts produced by sand casting. Since the mold cavity and cores are made of compressed sand, sand-cast parts typically exhibit poor surface finish and dimensional accuracy. The use of sprues and runners to direct molten metal to different parts of the mold cavity may adversely affect the yield of sand casting processes and the quality of sand-cast parts. Since gravitation force drives the molten metal through the gating system, the time taken to fill the mold cavity may be high. Additionally, the temperature of the molten metal may drop while flowing through the gating system. If the molten metal cools to the metal-solidification temperature in the gating system, incomplete filling of the mold cavity may result. Thus, it is traditional to pour molten metal into the pouring cup at a higher temperature to prevent solidification of the metal in the gating system. Pouring the molten metal at such a high temperature, however, may result in a flow that is somewhat turbulent. Accordingly, with the molten metal poured at such a high temperature, heat may be readily transferred to the sand walls of the mold, causing the sand particles to fracture and therefore produce a poor surface finish on the metal casting. High pouring temperature may also produce poorer microstructure in the portions of the part that solidify last.

U.S. Pat. No. 5,503,214 issued to Cribley et al. (the '214 patent) describes a sand casting process in which the gating system eliminates runners. In the gating system of the '214 patent, a pouring cup is fluidly coupled to a mold cavity through a vertical down sprue. Molten metal, poured into the pouring cup, is delivered to the mold cavity through the vertical down sprue. A sand core, placed in the mold cavity, defines the shape of a disk rotor that may be cast using the sand casting process of the '214 patent. When the mold is fully assembled, the down sprue connects to a flow passage extending through the core in the mold cavity. A filter element placed in the flow path of the '214 patent, filters particulates from the molten metal and provides a flow-constricting gap, to slow the flow of molten metal into the mold cavity. The down sprue also serves as a riser to provide a reservoir of molten metal to fill voids formed during shrinkage. By eliminating runners the method of the '214 patent may eliminate some deficiencies associated with typical sand casting processes (discussed earlier). However, the sand casting process of the '214 patent may have drawbacks. For instance, the use of a sand core may result in poor dimensional accuracy and surface finish of the cast part. Additionally, the down sprue of the '214 patent may restrict the flow of molten metal into the mold cavity, thereby increasing the time taken to fill the mold cavity. As discussed above, restriction of the molten metal flow into the mold cavity may increase the temperature drop of the molten metal in the gating system, negatively impact directional solidification, and increase the formation of shrink defects.

### SUMMARY

In one aspect, a mold assembly for sand casting is disclosed. The mold assembly includes a drag having a first vertical axis and a first surface. The first surface extends generally perpendicular to the first vertical axis. The mold assembly also includes a cope having a second vertical axis positioned on the first surface such that the first vertical axis and the second vertical axis coincide to form a central vertical axis. The cope includes a second surface and a third surface both extending generally perpendicular to the second vertical axis. The mold assembly also includes a casting cavity disposed about the central vertical axis and located between the first surface and the second surface, and a core disposed about the central vertical axis and positioned in the casting cavity. The mold cavity further includes a pouring cup disposed about the second vertical axis and extending downward from the third surface to the casting cavity. The pouring cup is configured to deliver a substantial portion of liquid material at a time directly into the casting cavity without directing the liquid material through a choke point.

In another aspect, a method of sand casting a part is disclosed. The method includes forming a casting cavity between a cope and a drag of a molding assembly such that the casting cavity is located about a vertical axis of the molding assembly. The method also includes directing a substantial portion of liquid material at a time directly into casting cavity without directing the liquid material through a choke point. The method further includes shaping the liquid material in the casting cavity using a ceramic core, and solidifying the liquid material in the casting cavity to form a casting having a shape substantially resembling the part.

In yet another aspect, a method of creating a mold for sand casting a part is disclosed. The method includes forming a casting cavity between packed aggregate material of a cope and packed aggregate material of a drag. The cope and the drag being parts of a molding assembly having a central vertical axis, and the casting cavity is disposed about the central vertical axis. The method also includes locating a pouring cup on the cope. The pouring cup is shaped substantially like a frustum of a cone and is configured to deliver a substantial portion of a molten liquid at a time to the casting cavity without directing the molten liquid through a choke point. The method further includes positioning a ceramic core in the casting cavity such that the core is circumferentially disposed about the central vertical axis, the core being shaped such that a free space in the casting cavity not occupied by the core substantially resembles a shape of the cast part.

### BRIEF DESCRIPTION OF THE DRAWINGS

FIG. 1A is a schematic illustration of an exemplary mold assembly for the disclosed precision casting process;

FIG. 1B is a schematic illustration of a cross-sectional view of the mold assembly of FIG. 1A; and

FIG. 2 is a schematic illustration of an exemplary part cast using the mold assembly of FIG. 1A.

### DETAILED DESCRIPTION

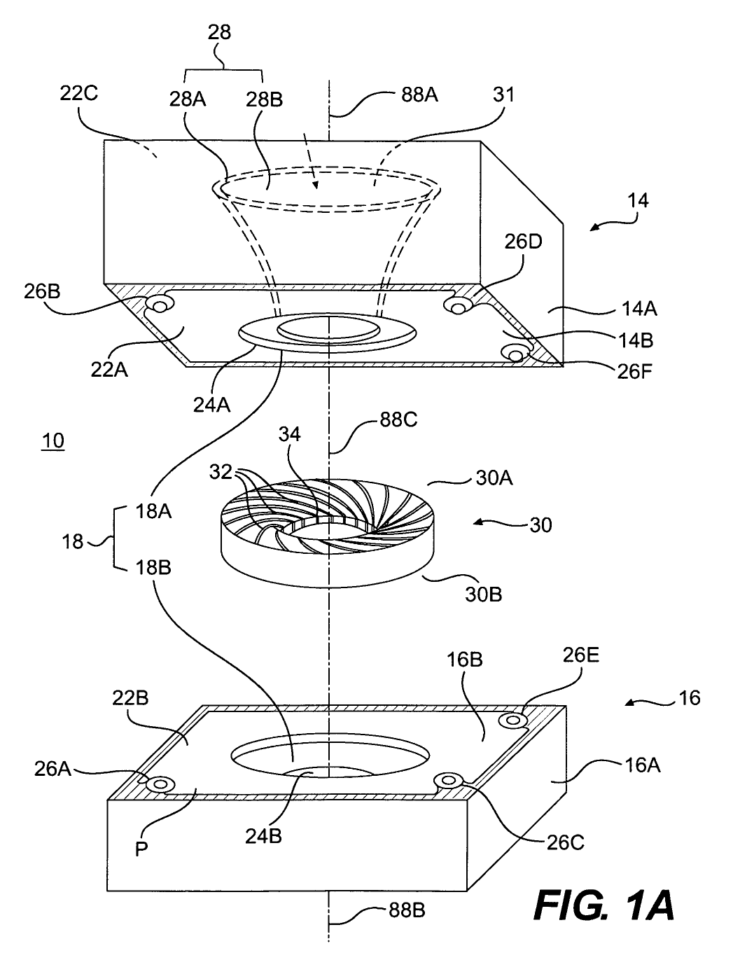

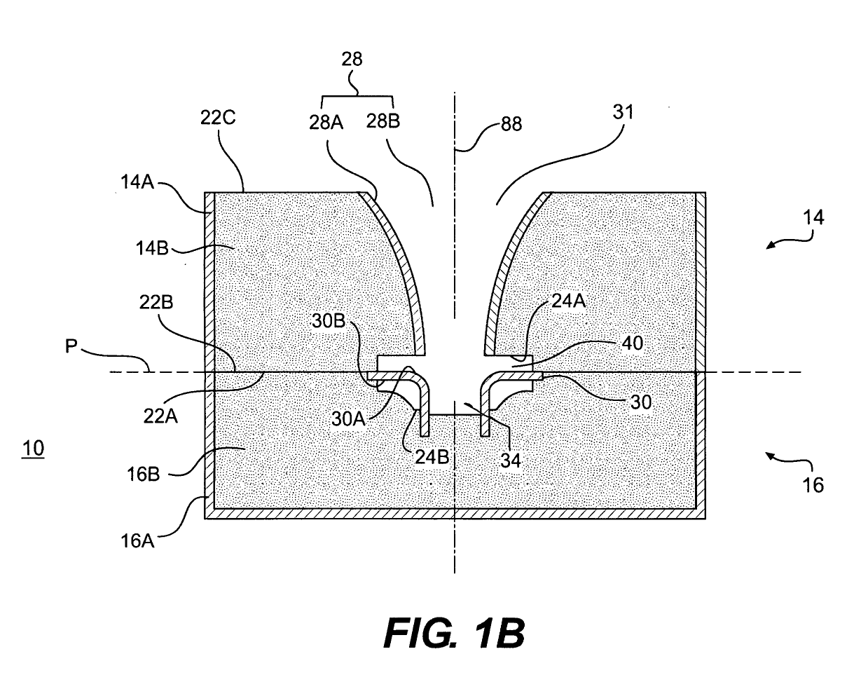

FIGS. 1A and 1B illustrate an exemplary mold assembly 10 for performing an embodiment of the disclosed precision casting process. Mold assembly 10 includes a two-part flask having an upper cope section (cope) 14 and a lower drag section (drag) 16. FIG. 1A illustrates the mold assembly 10 in an open configuration, while FIG. 1B illustrates a cross-sectional view of mold assembly 10 with cope 14 and drag 16 joined together (that is, a closed configuration). As FIG. 1B shows, when mold assembly 10 is fully assembled, cope 14 and drag 16 are joined to one another in a separable manner along a generally horizontal parting plane P. Reference will be made to both FIGS. 1A and 1B in the discussions that follow.

Cope 14 and drag 16 may each include a casing (cope casing 14A and drag casing 16A) containing an aggregate material (cope aggregate 14B and drag aggregate 16B), such as, for example sand. Cope casing 14A and drag casing 16A may be made of any material, such as, for example, wood, steel, etc. One or both of cope casing 14A and drag casing 16A may include handles or other similar features (not shown) configured to enable an operator to lift the casing. As can be seen in FIG. 1A, cope aggregate 14B may include a cope print 18A, and drag aggregate 16B may include a drag print 18B. Cope print 18A may be a depression disposed about a first vertical axis 88A with an upper cavity wall 24A spaced apart from a bottom surface 22A of cope 14. Drag print 18B may be a depression disposed about a second vertical axis 88B and having a lower cavity wall 24B spaced apart from a top surface 22B of drag 16.

As can be seen in FIG. 1B, when cope 14 is placed over drag 16, bottom surface 22A may rest on top surface 22B along parting plane P. Additionally, first vertical axis 88A may be coincident with second vertical axis 88B, and cope print 18A and drag print 18B may jointly define a casting cavity 18 therebetween. Casting cavity 18 may thus be a cavity formed between cope 14 and drag 16 having mutually spaced upper 24A and lower 24B cavity walls. Cope 14 and drag 16 may include locating features 26A-26F that enable cope 14 and drag 16 to be aligned such that cope print 18A and drag print 18B jointly define casting cavity 18. Locating features 26A-26F may include any type of features configured to suitably align cope print 18A and drag print 18B. In some embodiments, locating features 26A-26F may include male and female locating features. In general, one locating feature of a pair of locating features on cope 14 and drag 16 may have a male configuration while the other locating feature may have a female configuration. In the embodiment depicted in FIG. 1A, locating features 26B, 26D, and 26F on cope 14 have a male configuration, while locating features 26A, 26C, and 26E have a female configuration. It is contemplated that other embodiments may have different configurations.

Mold assembly 10 may also have a flow path 31 extending from a top surface 22C of cope 14 to casting cavity 18. Flow path 31 may include a pouring cup 28 extending through cope aggregate 14B and fluidly communicating top surface 22C of cope 14 with bottom surface 22A. In some embodiments, pouring cup 28 may extend from top surface 22C to upper cavity wall 24A of cope print 18A. Pouring cup 28 may include a shell 28A that defines a vertical cavity 28B through cope aggregate 14B. Shell 28A may be made of any material, such as, for example, steel, ceramic, etc. In some embodiments, shell 28A may be eliminated and pouring cup 28 may consist of vertical cavity 28B defined through cope aggregate 14B. Pouring cup 28 may be circumferentially disposed about first vertical axis 88A and may be centrally positioned relative to cope print 18A. As seen in FIG. 1B, when cope 14 is disposed on drag 16, cavity 28B of pouring cup 28 may provide access to, and may be centrally positioned relative to, casting cavity 18.

Flow path 31 may be configured to deliver a substantial portion of liquid material at a time directly into casting cavity 18 without directing the liquid material through any choke points. In some embodiments, pouring cup 28 may be configured to deliver the liquid material directly into casting cavity 18 without presenting any choke points in the flow path 31. Delivering a substantial portion of liquid material at a time directly into casting cavity 18 (as opposed to directing a trickle of liquid material into casting cavity 18) may fill casting cavity 18 quickly. A choke point may be a geometric feature that disrupts a steady and continuous flow of the liquid material into casting cavity 18. In other words, a choke point may be a location in flow path 31 that may inhibit, or offer resistance to, the flow of liquid material into casting cavity 18. When a choke point is present in flow path 31, liquid material poured into pouring cup 28 may accumulate in pouring cup before (or while) filling casting cavity 18. In contradistinction, when liquid material is poured into flow path 31 without any choke points, the liquid material may fill casting cavity 18 before collecting in pouring cup 28 (or another component that fluidly couples pouring cup 28 to casting cavity 18). To illustrate typical choke points that may be present in a flow path 31, a few non-limiting examples will now be described. In a typical sand casting gating system, a location where a sprue connects to a pouring cup may act as a choke point due to the abrupt change in cross-sectional dimensions of the flow path. A filter element in flow path 31 may also act as a choke point by restricting the flow of liquid material into the casting cavity 18.

If flow path 31 included any choke points, some of the liquid material may collect in flow path 31 (before proceeding to casting cavity 18), thereby slowing the flow of liquid material into casting cavity 18. It is contemplated that, if flow path 31 is aligned about an axis (as in FIG. 1B), it may be possible to pour a small stream, or a trickle, of liquid material directly into casting cavity 18 without the liquid material collecting in flow path 31. However, in this case, the time needed to fill casting cavity 18 with liquid material may increase. That is, both the presence of choke points in flow path 31, and delivering a small portion of liquid material at a time directly into casting cavity 18 may increase the time needed to fill casting cavity 18. In contrast, the absence of choke points in flow path 31 and delivering a substantial portion of liquid material at a time directly into casting cavity 18 may decrease the time needed to fill casting cavity 18. An increase in time needed to fill casting cavity 18 with liquid material may increase the temperature drop that the liquid material undergoes before it fills casting cavity 18. In the case of a flow path 31 with a choke point, this temperature drop may be a result of the increased time needed to traverse the flow path 31, while in the case of pouring a small portion of liquid material at a time directly into casting cavity 18, the temperature drop may be a result of the increased time needed to fill casting cavity 18. In either case, increasing temperature drop of the molten liquid while filling casting cavity 18 may require that the molten liquid be poured into flow path 31 at a higher temperature to prevent the molten liquid from solidifying before casting cavity 18 is filled. As discussed previously, pouring the liquid material at a higher temperature may negatively affect the quality of a part produced using mold assembly 10.

Pouring cup 28 may also be configured to act as riser during the casting process. That is, after filling casting cavity 18, additional liquid material may accumulate in pouring cup 28. This reservoir of liquid material accumulated in pouring cup 28, may subsequently flow into casting cavity 18 to fill voids created when the liquid material in casting cavity 18 solidifies.

In the embodiment of mold assembly 10 depicted in FIGS. 1A and 1B, pouring cup 28 may substantially resemble a frustum of a cone with side walls that continuously taper inwardly as they extend from top surface 22C to bottom surface 22A. It is also contemplated that other embodiments of mold assembly 10 may include other shapes of pouring cup 28. In general, any shape of pouring cup 28 that does not direct liquid material through a choke point while filling casting cavity 18, and may serve as a riser during material solidification, may be used in different embodiments of the precision casting process of the current disclosure. For example, in some embodiments, pouring cup 28 may substantially resemble a funnel. In such an embodiment, pouring cup 28 may include a first conical section coupled along first vertical axis 88A to a second conical section (or a substantially cylindrical section), to fluidly communicate top surface 22C to casting cavity 18. The first conical section may taper down from a first diameter on top surface 22C to a second diameter at a location between top surface 22C and bottom surface 22A. The second conical section may taper down from the second diameter to a smaller diameter at upper cavity wall 24A of casting cavity 18. In some embodiments, a substantially cylindrical section may couple the first conical section to casting cavity 18. In all such embodiments, however, diameters at locations along flow path 31 (such as, first diameter, second diameter, and smaller diameter) may be designed to avoid creating a choke point in flow path 31 and to deliver a substantial portion of liquid material at a time directly into casting cavity 18. The value of these diameters in an application may depend upon the geometric properties of the part to be cast (such as, size and design details of the part) and flow properties of the liquid material.

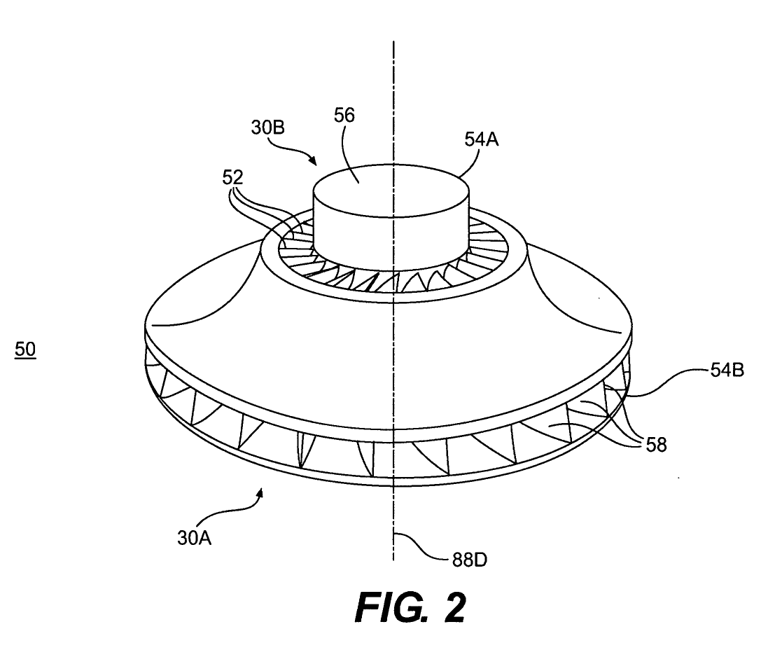

A casting core 30 may be disposed in casting cavity 18. The core 30 may be designed to shape the liquid material delivered to casting cavity 18. Core 30 may include passageways and/or other geometries to impart a desired shape to the liquid material in casting cavity 18. When the liquid material in casting cavity 18 solidifies, the resulting part formed of the solidified material (hereinafter “cast part” 50) may retain the shape imparted by core 30. As an illustrative example, FIG. 1A depicts core 30 configured to create a cast part 50 having the shape of a shrouded impeller. FIG. 2 shows an exemplary embodiment of cast part 50 in the form of a shrouded impeller, cast in mold assembly 10. In the discussion below, FIGS. 1A, 1B, and 2 will be referenced to describe the relation between a shape of core 30 and a shape of the resulting cast part 50. It should be emphasized that the shrouded impeller illustrated in FIG. 2 is only exemplary of a cast part 50 that may be formed using the precision casting process of the current disclosure. Any shape of cast part 50 may be formed in mold assembly. A cast part 50 of a different shape may be formed by using a different shaped core or locating the core 30 differently within casting cavity 18. For example, an open faced impeller may be formed by using a different core in casting cavity 18.

As best seen in FIG. 1A, core 30 may be an annular part disposed circumferentially about a third vertical axis 88C (shown concentric to vertical axes 88A and 88B in FIG. 1A). Core 30 may extend along third vertical axis 88C from a first end 30A to a second end 30B. Core 30 may include multiple passageways 32 extending from first end 30A toward second end 30B. These passageways 32 may be shaped to form blades 52 of cast part 50. For instance, the shape of passageways 32, from first end 30A to second end 30B may correspond to the shape of blades 52 of cast part 50 from a first end 36A to a second end 36B of cast part 50. The shape of passageways 32 in radial directions relative to third vertical axis 88C may also correspond to the shape of blades 52 extending in radial directions relative to a vertical axis 88D of cast part 50. Core 30 may also include a cavity 34 with third vertical axis 88C passing centrally thereof. Although, cavity 34 may have any shape, in some embodiments, cavity 34 may be circular. A diameter of cavity 34 may correspond to a diameter of a flange 54A of cast part 50. One end of passageways 32 may open into cavity 34 and an opposite end of passageways may terminate at a location within core 30.

Core 30 may be constructed of various materials. For example, core 30 may typically be made of a refractory material. In some embodiments, core 30 may be made of a ceramic material and have a smooth surface finish. In this disclosure, the term smooth is used to refer to a surface finish that is substantially non grainy. A core made of pressed sand or other aggregate material may exhibit a rough or a grainy surface finish, while a core made of a ceramic material may exhibit a smooth, polished or a non grainy surface finish. The smooth surface finish of core 30 may translate to reduced surface roughness of a part cast in casting cavity 18.

To dispose core 30 in casting cavity 18, core 30 may be placed in drag print 18B with second end 30B proximate lower cavity wall 24B. In some embodiments, core 30 and drag print 18B may be dimensioned such that core 30 may have an interference fit with drag print 18B. Additionally, in some embodiments, when core 30 is placed in drag print 18B, third vertical axis 88C may substantially coincide with second vertical axis 88B. In some embodiments, core 30 may be placed in drag print 18B such that second end 30B of core 30 may touch lower cavity wall 24B. For example, to form an open faced impeller in mold assembly 10, a suitable core may be placed in drag print 18B such that the core is flush with lower cavity wall 24B.

With the core 30 placed in drag print 18B, the mold assembly 10 may be closed. That is, cope 14 may be placed over drag 16. In the closed configuration, locating features 26A-26F on cope 14 and drag 16 may align cope print 18A and drag print 18B to form casting cavity 18 with core 30 disposed therein. As shown in FIG. 1B, when mold assembly 10 is closed, first vertical axis 88A, second vertical axis 88B, and third vertical axis 88C may coincide to form vertical axis 88. With mold assembly 10 closed, upper cavity wall 24A and lower cavity wall 24B of casting cavity 18 may be in a spaced relationship with first end 30A and second end 30B respectively of core 30. In this configuration, free space 40 in casting cavity 18 may substantially resemble the shape of the cast part 50 to be produced. That is, the shape of free space 40 in casting cavity 18 may be a negative of the shape of the cast part 50 to be made. Free space 40 may be the space in casting cavity 18 not occupied by core 30. Free space 40 may include the space within passageways 32 and cavity 34 of core 30. Free space 40 may also include space between first end 30A and upper cavity wall 24A, and second end 20B and lower cavity wall 24B.

Liquid material, poured into casting cavity 18 through pouring cup 28, may fill free space 40, and solidify to form cast part 50. In some embodiments, the surface of core 30 may be smooth to impart a smooth surface finish to cast part 50. Additionally, in some embodiments, liquid material may include molten liquid metal. In such embodiments, solidification may occur when the molten liquid metal in free space 40 of cavity 18 cools. When the molten metal solidifies, the liquid material in passageways 32 may form blades 52, liquid material in cavity 34 may form flange 54A, liquid material in the space between first end 30A and upper cavity wall 24A may form base 54B, and the liquid material in the space between second end 30B and lower cavity wall 24B may form the shroud 60.

### INDUSTRIAL APPLICABILITY

The disclosed embodiments relate to a sand casting process for making precision parts. The process includes using a pouring cup, attached to a cope of a mold assembly, to directly pour liquid material into a mold cavity of the mold assembly without directing the liquid material through a choke point. A ceramic core having a smooth surface finish is disposed within the mold cavity such that space in the mold cavity not occupied by the core substantially resembles the shape of the part to be cast. Pouring liquid material directly into the mold cavity without the use of sprues and runners enables the mold cavity to be filled quickly without a significant temperature drop of the liquid material during the pouring process, thereby favoring directional solidification of a cast part. The use of a ceramic core with a smooth surface finish also improves the surface finish of the cast part and allows casting the part with dimensions close to the desired final dimensions for the part. To illustrate the disclosed precision casting process, a method of casting an impeller will now be described.

Drag 16 of mold assembly 10 may be loosely filled with sand and a pattern (not shown) placed on top surface 22B thereof. The sand may include a binder or other chemicals that promote adhesion between the sand particles. The shape of the pattern may substantially resemble the shape of casting cavity 18. The pattern may be pressed into top surface 22B so as to create a depression resembling drag print 18B on the sand in drag 16. Cope 14 may now be placed on top surface 22B such that locating features 26B, 26D, and 26F on cope 14 mate with locating features 26A, 26C, and 26E on drag 16. In this configuration, first vertical axis 88A may coincide with second vertical axis 88B. Pouring cup 28, having a shape resembling a frustum of a cone, may be placed within cope 14 such that a longitudinal axis of pouring cup 28 coincides with first vertical axis 88A. Pouring cup 28 may be oriented in cope 14 such that a smaller diameter end of pouring cup 28 abuts the pattern placed on top surface 22B of drag 16, and an opposite larger diameter end of pouring cup 28 extends from top surface 22C of cope 14. Sand may now be poured into cope 14 around pouring cup 28 and compacted. Compaction of the sand in cope 14 may eliminate voids in the sand in cope 14 and drag 16, and tightly pack the sand around the pattern and pouring cup 28. Cope 14 may now be gently lifted off drag 16, and the pattern removed. Impression of the pattern on the sand in the cope 14 may create cope print 18A on bottom surface 22A, and impression of the pattern on sand in drag 16 may create drag print 18B on top surface 22B.

After creation of drag print 18B and separation of cope 14 from drag 16, core 30, made of a ceramic material, may be placed in drag print 18B. In this configuration, second end 30b of core 30 may be in a spaced relationship with lower cavity wall 24B of drag print 18B. Core 30 may be constructed such that outer surfaces of core 30 may have a smooth surface finish. After core 30 is placed in drag print 18B, cope 14 and drag 16 may be closed. In the closed configuration, cope print 18A may join with drag print 18B to form casting cavity 18 with core 30 located in therein. In this configuration, pouring cup 28 may provide a flow path 31 that fluidly communicates top surface 22C of cope 14 with casting cavity 18 (see FIG. 1B). In this configuration, first vertical axis 88A, second vertical axis 88B, and third vertical axis 88C may coincide to form vertical axis 88. Core 30 may include geometric features (such as passageways 32 and cavity 34) and may be shaped and dimensioned such that free space 40 in casting cavity 18 (space not occupied by core 30) may resemble the shape of a shrouded impeller (see FIG. 2).

Molten liquid metal may be poured into casting cavity 18 through the flow path 31 provided by pouring cup 28. The liquid metal may fill free space 40 in casting cavity 18. In some embodiments, the amount of molten metal poured into pouring cup 28 may be such that a reserve of molten metal remains in pouring cup 28 after the molten metal has filled free space 40 in casting cavity 18. As the temperature of the molten metal in casting cavity 18 decreases, the molten metal may solidify. The shape of pouring cup 28 and free space 40 may favor the solidification of molten metal in contact with lower cavity wall 24B first. As the metal solidifies, the metal shrinks, creating voids (shrink voids), and liquid metal from surrounding regions move in to fill these voids. The reserve of liquid metal in pouring cup 28 may replace the liquid metal in casting cavity 18 used to fill the shrink voids, thereby keeping casting cavity 18 full of metal during the solidification process. Solidification of liquid metal may thus proceed from the lower cavity wall 24B towards the reserve of molten metal in pouring cup 28.

After the liquid metal in casting cavity 18 solidifies, cope 14 may be separated from drag 16, and the solidified cast part 50 removed from casting cavity 18. In some cases, cast part 50 along with core 30 may be taken from the casting cavity 18, and core 30 broken away from cast part 50. The surface of cast part 50 in contact with core 30 may have a smooth surface finish due to the smooth surface finish of core 30. Machining and/or other material-removal operations may be carried out to give the cast part 50 its desired final shape and dimensions. The material-removal operations may include machining a through-hole 56 through flange 54A of cast part 50.

The use of a ceramic core while casting the impeller may reduce post-casting machining operations needed to finish the impeller to desired dimensions. The smooth surface finish of the core may also improve the surface finish of the surfaces of the impeller in contact with the core. This improved surface finish may reduce, or eliminate, the need for polishing operations for polishing the surfaces of blades 52 in passageways 58 of the impeller.

Elimination of sprues and runners from the gating system of the mold assembly allows the molten liquid to be poured directly into the casting cavity without creating a choke point in flow path 31. Pouring the molten liquid directly into the casting cavity allows the casting cavity to be filled quickly without an appreciable drop in temperature of the molten liquid. Limiting the temperature drop of the molten liquid during the pouring process enhances directional solidification of the molten liquid in the casting cavity and decreases the formation of shrink defects.

It will be apparent to those skilled in the art that various modifications and variations can be made to the disclosed precision casting process. Other embodiments will be apparent to those skilled in the art from consideration of the specification and practice of the disclosed precision casting process. It is intended that the specification and examples be considered as exemplary only, with a true scope being indicated by the following claims and their equivalents.

What is claimed is:

1. A mold assembly for sand casting, comprising:
a drag having a first vertical axis and a first surface, the first surface extending generally perpendicular to the first vertical axis;
a cope having a second vertical axis positioned on the first surface such that the first vertical axis and the second vertical axis coincide to form a central vertical axis, the cope including a second surface and a third surface both extending generally perpendicular to the second vertical axis;
a casting cavity disposed about the central vertical axis and located between the first surface and the second surface;
a core disposed about the central vertical axis and positioned in the casting cavity; and
a pouring cup disposed about the second vertical axis and extending downward from the third surface to the casting cavity, the pouring cup being configured to deliver a substantial portion of liquid material at a time directly into the casting cavity without directing the liquid material through a choke point.

2. The mold assembly of claim 1, wherein the core is made of a ceramic material.

3. The mold assembly of claim 2, wherein the core has a smooth surface finish.

4. The mold assembly of claim 1, wherein a free space in the casting cavity not occupied by the core is substantially shaped like an impeller.

5. The mold assembly of claim 4, wherein the core includes passageways substantially shaped like blades of the impeller.

6. The mold assembly of claim 1, wherein the pouring cup has a shape substantially resembling a frustum of a cone.

7. The mold assembly of claim 6, wherein a first end of the pouring cup forms an opening on the third surface and a second end of the pouring cup forms an opening on the second surface.

8. The mold assembly of claim 1, wherein the pouring cup includes a shell defining a flow path into the casting cavity.

9. The mold assembly of claim 1, wherein the casting cavity and the pouring cup are surrounded by packed sand.

10. The mold assembly of claim 1, wherein the casting cavity includes a first cavity disposed on the drag and a second cavity disposed on the cope and the core is positioned on the first cavity.

11. A method of sand casting a part, comprising:
forming a casting cavity between a cope and a drag of a molding assembly, the casting cavity being located about a vertical axis of the molding assembly;
directing a substantial portion of liquid material at a time directly into casting cavity without directing the liquid material through a choke point;
shaping the liquid material in the casting cavity using a ceramic core; and
solidifying the liquid material in the casting cavity to form a casting having a shape substantially resembling the part.

12. The method of claim 11, wherein the liquid material includes a molten liquid metal.

13. The method of claim 11, wherein directing liquid material into the casting cavity along the flow path includes directing liquid material from a pouring cup coupled to the cope directly into the casting cavity.

14. The method of claim 13, wherein directing liquid material into the casting cavity includes filling free space in the casting cavity with the liquid material, and holding a reserve of the liquid material in the pouring cup after the filling of the free space.

15. The method of claim 11, wherein the part is an impeller and shaping the liquid material includes shaping the liquid material to form blades of the impeller having a smooth surface finish.

16. The method of claim 11 further including, removing the cast part from the molding assembly.

17. The method of claim 16, wherein removing the cast part includes breaking the core to separate the cast part from the core.

18. A method of creating a mold for sand casting a part, comprising:
forming a casting cavity between packed aggregate material of a cope and packed aggregate material of a drag, the cope and the drag being parts of a molding assembly having a central vertical axis, and the casting cavity being disposed about the central vertical axis;
locating a pouring cup on the cope, the pouring cup being shaped substantially like a frustum of a cone and being configured to deliver a substantial portion of a molten liquid at a time to the casting cavity without directing the molten liquid through a choke point; and
positioning a ceramic core in the casting cavity such that the core is circumferentially disposed about the central vertical axis, the core being shaped such that a free space in the casting cavity not occupied by the core substantially resembles a shape of the cast part.

19. The method of claim 18, wherein one end of the pouring cup forms an opening on an external surface of the cope and an opposite end of the pouring cup forms an opening on a wall of the casting cavity.

20. The method of claim 18, wherein positioning the ceramic core includes positioning the core having a smooth surface finish in the casting cavity.
